(19) United States
(12) Patent Application Publication
(10) Pub. No.: US 2016/0358115 A1
(43) Pub. Date: Dec. 8, 2016

(54) QUALITY ASSURANCE ANALYTICS SYSTEMS AND METHODS

(71) Applicant: Mattersight Corporation, Chicago, IL (US)

(72) Inventors: David GUSTAFSON, Lake Bluff, IL (US); Christopher DANSON, Austin, TX (US); Stephen Richard HOWE, Austin, TX (US); Charles Franklyn MACK, Austin, TX (US)

(21) Appl. No.: 14/731,018

(22) Filed: Jun. 4, 2015

(51) Int. Cl. G06Q 10/06

(52) U.S. Cl. CPC G06Q 10/06395

(57) ABSTRACT

Systems and techniques for automated quality assurance are disclosed. The systems receive and analyze communications between customers and customer service agents for quality assurance purposes, select a sub-set of communications for further quality assurance review, and display analysis results to a user.

### TECHNICAL FIELD

The present disclosure generally relates to methods, apparatuses, and systems related to automated quality assurance, and more specifically, to recording and analyzing electronic communications for quality assurance purposes.

### BACKGROUND OF THE DISCLOSURE

Many customer contact centers conduct Quality Assurance (QA) procedures to improve the performance of employees and business systems. Generally, QA procedures are performed manually by contact center employees, known as QA monitors, who have to review records and select a subset of customer calls for further review. Most contact centers employ agents who communicate with customers via telephonic communication. Other types of electronic communication such as social media, chats, email, etc., however, are becoming more widespread. Regardless of the communication medium, a customer generally interacts with a contact center agent to answer questions or solve problems. Because many contact centers initiate or receive hundreds of telephone calls per day, QA monitors typically select only a small number of calls to monitor for QA purposes. The calls may be monitored to evaluate the contact center agent or to meet certain QA objectives. Each contact center has its own criteria for analyzing calls for QA purposes. Contact centers typically have a goal for the number or percentage of calls that are reviewed each month. Different divisions within the call center may have different review requirements, and each division might have its own form for QA review.

A QA monitor might review, for example, 4-5 calls or a selected percentage of calls per month for each contact center agent. Generally, QA monitors fill out a QA form for each call and record on the form general data such as whether or not the agent greeted the caller by name, used a pleasant tone, was knowledgeable and helpful, or asked if there was anything else the agent could help the caller with. Furthermore, since many contact centers employees use computers to assist in customer service, a QA monitor may observe a contact center agent's screen activity during one or more calls such as when the agent has been flagged as needing training or more careful review.

Generally, contact centers assign calls to available QA monitors manually. This method is inefficient because it can poorly match calls to QA monitors, fail to assign calls with important information, and otherwise take valuable QA monitor time away from actually assessing customer communications for quality assurance. Thus, there is a need for a system, apparatus, and methods to automate QA analysis of calls and electronic communications.

### SUMMARY

The present disclosure describes methods and systems that provide QA analysis of electronic communications. The present methods identify customer communications that need quality assurance review and provide the results of the review to a user. The results can then be used to facilitate improved customer interactions.

In one aspect, the present disclosure relates to an automated quality assurance system that includes a processor and non-transitory computer non-transitory computer readable medium operably connected to the processor. The non-transitory computer readable medium includes a plurality of instructions stored in association therewith that are accessible to, and executable by, the processor. The plurality of instructions include instructions that, when executed, receive a communication between a customer and a customer service agent; instructions that, when executed, analyze the communication according to one or more criteria to determine when quality assurance review is required; instructions that, when executed, match the communication to a quality assurance monitor; and instructions that, when executed, display results of a quality assurance analysis by the quality assurance monitor.

In a second aspect, the present disclosure relates to a method of conducting a quality assurance analysis. The method includes receiving a communication between a customer and a customer service agent; identifying attributes in the communication that signal that quality assurance review of the communication is required; selecting the communication for further review when the attributes are identified in the communication; performing a first quality assurance analysis on the selected communication; and displaying the results of the first quality assurance analysis.

In a third aspect, the present disclosure relates to an automated quality assurance system that includes an analytics engine, an assignment engine, a communication engine, and a display component. The analytics engine is configured to receive a communication between a customer and a customer service agent; and select the communication after determining that the communication needs further review. The communications engine is configured to match the selected communication with a quality assurance monitor. The communication engine is configured to transmit the selected communication to the quality assurance monitor. The display component is configured to display results of a quality assurance analysis by the quality assurance monitor.

In a fourth aspect, the present disclosure relates to a non-transitory computer readable medium that includes a plurality of instructions, which in response to a computer system, cause the computer system to perform a method. The method includes receiving a communication between a customer and a customer service agent; determining whether the communication meets certain predetermined selection requirements; selecting the communication for quality assurance review when the communication meets the certain predetermined selection requirements; performing a first quality assurance analysis on the selected communication; displaying results of the first quality assurance analysis; and recommending that one or more actions be taken

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1a illustrates an embodiment of an embodiment of a contact center according to various aspects of the present disclosure.

FIG. 1b illustrates an embodiment of a QA system according to various aspects of the present disclosure.

FIG. 2 is a block diagram of a QA device suitable for implementing one or more components in FIGS. 1a and 1b according to one embodiment of the present disclosure.

FIG. 3 illustrates a display of a QA device according to one embodiment of the present disclosure.

FIG. 4 is a flowchart illustrating a method of conducting a QA analysis according to various aspects of the present disclosure.

FIG. 5 is a flowchart illustrating a method of conducting a QA analysis according to various aspects of the present disclosure.

### DETAILED DESCRIPTION OF THE PREFERRED EMBODIMENTS

The present disclosure relates to methods and systems that capture and analyze voice and nonverbal data from phone calls or other electronic communications for QA purposes. Recordings of customer service communications are provided, and the methods, apparatuses, and systems employ an analytics engine to pre-select and review specified data from the communications to determine whether further quality assurance review will be conducted.

In various embodiments, the methods are automated for detecting potential problems and preemptively taking action to provide consistent, quality customer service. This, in turn, leads to improved customer communication handling and satisfaction.

In a first aspect, a plurality of communications between customers and customer service or contact center agents are recorded. This step may include recording phone calls or capturing data from electronic interactions such as chat, e-mail, social media (e.g., Facebook posts), video interactions, or web interactions. Both verbal and non-verbal data is collected from the communications into a database. An analytics engine then analyzes both types of data to select a subset of the communications for QA review. The criteria for selection can be based on certain call center objectives, for example meeting a particular review threshold or benchmark, such as reviewing a certain percentage of calls each month, reviewing particular agents more carefully or extensively (e.g., if they are new, if they have more complaints, if they have more supervisor or escalation requests, if they have more customers with distress, if they have more customers with anger, if they have more failed transactions, etc.). In some embodiments, an assignment engine matches a selected communication with an appropriate QA monitor. The assignment engine may also associate the selected communications with an appropriate QA review form.

In a second aspect, the analytics engine converts the recordings of the communications into text to conduct the analysis. The analytics engine may then select a subset of the communications for QA review. Criteria for selection includes attributes such as anger, high value interactions (i.e., interactions that exceed, or are predicted to exceed, a value threshold), customer distress (and lack of empathy from an agent when distress is observed), legal threats, reference to a competitor, supervisor escalation, transfers to a certain destination, and/or resolution calls that address issues from previous calls.

In a third aspect, the analytics engine automatically performs a QA analysis itself on the recorded communications and optionally reports the results. In this case, the analysis may be conducted by using a combination of factors including identifying the tone used by the agent, determining whether the agent used the customer's name, and determining whether the agent seemed knowledgeable about the subject matter of the communication. These factors can be analyzed to determine when to conduct video capture of the agent's screen. In one embodiment, the analysis is conducted in real-time so that a decision to conduct video capture occurs while the agent is still communicating with the customer. The analytics engine may also determine when further QA review is required after the analysis of the communication is completed or after the communication is completed, or both.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, apparatuses, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

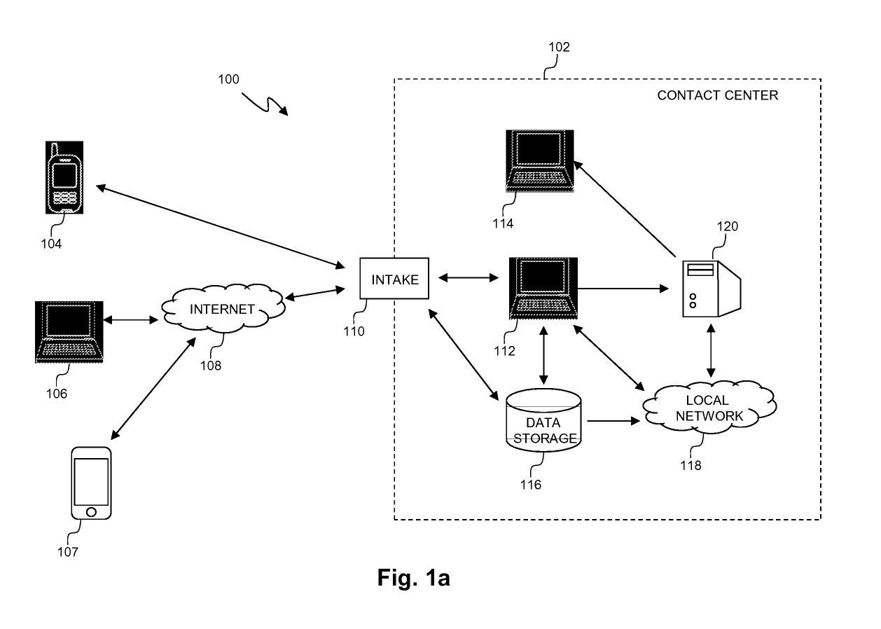

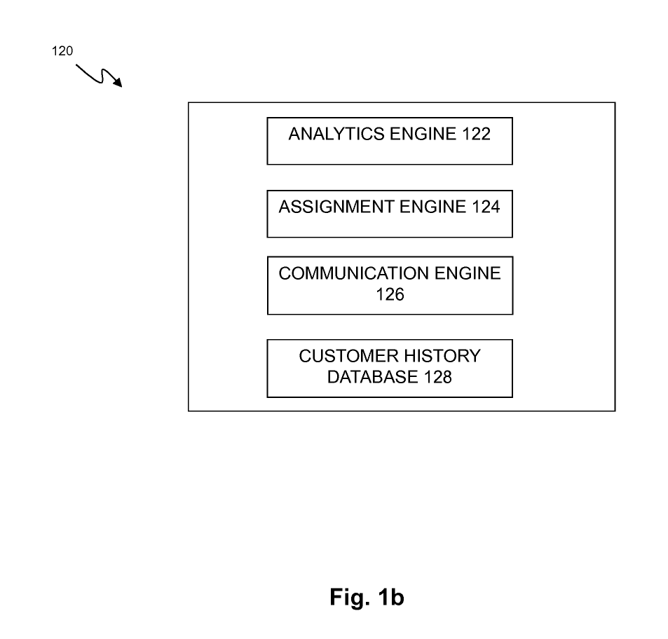

FIG. 1a depicts an exemplary embodiment of a contact center 102 according to various aspects of the present disclosure. A contact center 102 as used herein may include any facility or system server suitable for receiving and recording electronic communications from customers. Such communications can include, for example, telephone calls, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In various aspects, real-time communications, such as voice, video, or both, are included.

It is contemplated that these communications may be transmitted by and through any type of telecommunication device and over any medium suitable for carrying data. The communications may be transmitted by or through telephone lines, cable, or wireless communications. As shown in FIG. 1, the contact center 102 of the present disclosure is adapted to receive and record varying electronic communications and data formats that represent an interaction that may occur between a customer and a contact center agent during fulfillment of a customer and agent interaction. In one embodiment, the contact center 102 records all of the customer calls in uncompressed audio formats. In the illustrated embodiment, customers may communicate with agents associated with the contact center 102 via multiple different communication networks such as a public switched telephone network (PSTN) or the Internet 108. For example, customers may use cellular phones 104 or land lines to communicate with the contact center 102. Customers may also use computers 106 or personal communication devices 107 to contact the contact center 102 directly (not shown) or via the internet 108. Further, the contact center 102 may accept internet-based interaction sessions from personal computing devices 107, which may include VoIP telephones, internet-enabled smartphones, and personal digital assistants (PDAs). Additionally, customers may initiate an interaction session through fax machines or other legacy communication devices via the PSTN.

In some embodiments, telephone-based and internet-based communications are routed through an intake module 110. In one embodiment, the intake module 110 is located within the contact center 110. In this case, the intake module 110 may be operated by contact center agents or by an external department, such as a marketing department. In another embodiment, the intake module 110 is located off-site and may be operated by a third party, such as an analytics provider. In some cases, the intake module 110 collects data from the telephone or internet-based communications such as product information, location of customer, phone number, or other customer identification information. This information may be used to route the interaction to an appropriate contact center agent or supervisor. In one embodiment, the intake module 110 transmits collected information to a data storage unit 116 which may be accessed by contact center agents at a later time. It should be understood the data storage unit 116 may be offsite, either under the control of the contact center, under the control of an analytics provider, or under third party supervision, e.g., at a data farm. Furthermore, the intake module 110 (or communication distributor) may access the data storage unit 116 to access previous call records or internet-based interaction data for the purpose of appropriately routing an interaction.

After reaching the contact center 102, telephone or internet-based communications are routed to an agent device 112. The agent device 112 is an interface which allows a contact center agent to communicate with a customer. Examples of agent devices 112 include telephones and computers with communication capabilities including internet-based communication software, as well as tablets, PDAs, etc. The agent device 112 may be configured to record telephone or internet-based communications. These recordings include audio recordings, electronic recordings such as chat logs or emails, and may include video recordings. Recordings may be transmitted from the agent device 112 to a data storage unit 116 or a local network 118 within the contact center 102 or within an analytics provider for review by other contact center agents, supervisors, QA monitors, and the analytics engine of the present disclosure.

Still referring to FIG. 1, a QA system 120 is included as part of the contact center 102 or analytics provider and provides automated QA analytics for telephone or internet-based communications. The analytics provider may be on-site or remotely located. In one embodiment, the QA system 120 selects a subset of the total number of customer communications for QA analysis. In this case, information regarding customer communications is transmitted to the QA system 120 from a local network 118, data storage unit 116, or directly from an agent device 112. This information may include interaction identification data such as a phone number, customer ID, timestamp, or email address, as well as voice or video data from the interactions. The QA system 120 may convert the telephone or internet-based interactions into text before analysis.

Referring to FIG. 1b, the QA system 120 may include an analytics engine 122 that processes information from each customer-agent communication. In one embodiment, the analytics engine 122 determines whether any of the communications contain attributes that may signal that the communication requires additional QA analysis. Although not an exhaustive list, the attributes may include emotional cues such as anger, distress, and lack of empathy from an agent when distress is observed; evidence or prediction of high value interactions (e.g., that the interaction did or might exceed a value threshold), legal threats, reference to a competitor, supervisor escalation, transfers to a certain destination, discussion or resolution of issues in previous communications, or any combination thereof. Additionally, the analytics engine 122 may determine the type of tone the contact center agent used throughout the interaction, whether the agent used the customer's name, whether the agent asked the customer about additional needs, and whether the agent seemed knowledgeable. In some embodiments, the analytics engine 122 recommends certain actions to be taken based on results of the quality assurance analysis. For example, the analytics engine 122 may recommend that the contact center agent be provided additional customer service training and/or that future communications from a particular customer be routed to the best available contact center agent (e.g., which might be the same agent or a different agent, such as one with a more complementary personality type). Once the analytics engine 122 identifies the selected attributes in an interaction, it may transmit the selection to a QA monitor device 114 for further review. As discussed above, the QA monitor device 114 and one or more, or all, other aspects of the present disclosure may be offsite, such as at an analytics provider or another site remote from the contact center, rather than at the contact center 102 itself, or may be shared between a contact center and an analytics provider. In some embodiments, an assignment engine 124 of the QA system 120 matches a selected communication with an appropriate QA monitor. In various embodiments, a communication engine 126 transmits selected communications for review to, for example, QA monitor device 114.

The QA system 120 may also include a customer history database 128 for storing data regarding past or previous interactions with a customer. In various embodiments, past interactions with a customer are aggregated to better analyze communications between an agent and the customer. For example, if a review of the history of a customer reveals that he or she is always in distress, the customer history database 128 can reflect that and QA analysis can take this into account. Other information regarding a plurality of customers can be aggregated across customers, for example, based on personality type of the customers or of the agent that handled the customers, and considered in further QA analysis.

After desired or pre-selected attributes are identified as being present in a communication, the analytics engine 122 may apply one or more selection algorithms to determine when the interaction should undergo further QA analysis. The selection algorithms may take into account one or more factors, such as QA objectives for the contact center 102, work load data from the contact center 102, availability of QA monitors, skill levels or rankings of contact center employees or QA monitors, and complementary personality types between QA monitor and customers, QA monitor and agents, or complementary personality types between QA monitors, agents and customers. Use of the selection algorithms may allow the QA system 120 to selectively match communications with available QA monitors. Furthermore, the QA system 120 may use selection data to route communications based on the available QA monitors' proficiency at handling communications with particular characteristics. As many contact centers 102 require a QA form to be filled out for each selected communication, the QA system 120 may populate a QA form for each communication with identification data.

In some cases, information regarding customer communications is transmitted to the QA system 120 from the local network 118, data storage unit 116, or directly from an agent device 112. This information may include interaction identification data such as a phone number, customer ID, timestamp, or email address, as well as voice or video data from the communications. The QA system 120 may convert the telephone or internet-based interactions into text before analysis.

The QA system 120 may use the QA analysis of a communication to determine if the communication should have been recorded, or if the preliminary QA analysis is occurring in real-time during the customer communication, the recording or capture of video is initiated. For example, a contact center agent may conduct a communication with customers on a computer that has the capability to capture screenshots or a video recording of the communication. The agent may additionally record communications that he or she considers to be important, which in itself can be an additional factor used to select such communications for QA review according to the present disclosure. The agent may be given discretion to decide not to record some communications in the interest of saving memory space on the contact center 102 computers or data storage unit 116, and the QA system 120 may be permitted to override that decision in real-time and capture a portion of the communication for further review.

The QA system 120 may be used to determine when a communication is of sufficient importance that video aspects should have been recorded, either by screen capture or video recording. That agent, communications with that customer, or that type of communication generally can be flagged for such video capture in future communication recordings. Additionally, the QA system 120 may determine if the format of the communication was appropriate. For example, an agent may have the choice to conduct a customer communication via telephone, video interaction, web chat, or email. By analyzing the communication in real-time or a recording of the communication, the QA system 120 may be able to determine if the format chosen by the agent was appropriate, and help select agents to focus on customers using one or more particular modes of communication or to receive training regarding one or more modes of communication. This determination may be based on attributes as defined above, as well as a customer's requests or comments regarding the format choice if the customer is electing whether, for example, to communicate by chat, by email, or by phone.

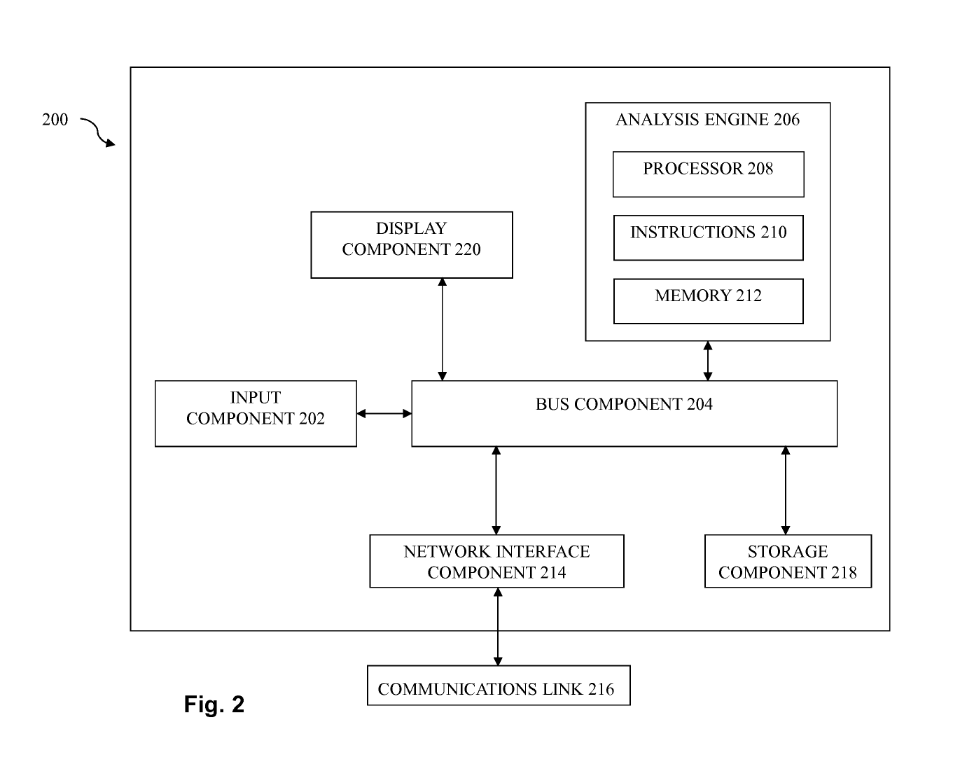

FIG. 2 shows a block diagram of an exemplary QA device 200. This device 200 may serve as the QA system 120. Alternatively, the device 200 may be combined with other devices to serve as the QA system 120. The QA device 200 includes components that may be interconnected internally including an input component 202, bus component 204, analysis engine 206, network interface component 214, communications link 216, storage component 218, and display component 220. The input component may be configured to receive transmissions from contact center sources, including identifying data from communications, real-time communications from agent devices 112, recordings from data storage module 116, or recordings from local network 118. The input module 202 may be configured to receive wireless transmissions. A bus component 204 may be used to interconnect components within the QA device 200 and facilitate communication between the various components. In some embodiments (such as the QA system 120), an analysis engine 206 is included in the QA device 200. The analysis engine 206 is equipped with at least a processor 208, instructions 210, and memory 212. The analysis engine 206 analyzes the various communications and recordings according to the instructions 210. In one embodiment, the analysis engine 206 converts the incoming communications into text, which are then analyzed according to the instructions 210. The instructions 210 may include criteria for selecting a subset of the communications that are transmitted to the QA device 200, including a list of attributes such as those discussed above. Additionally, the instructions 210 may be continuously updated by contact center employees with work load information or other time-sensitive information that may aid the QA device 200 in routing interactions for further QA analysis. The memory 212 included in the analysis engine 206 may include any one or a combination of volatile memory elements (e.g., random access memory (RAM, such as DRAM, SRAM, SDRAM, etc.)) and nonvolatile memory elements (e.g., ROM, hard drive, tape, CDROM, etc.).

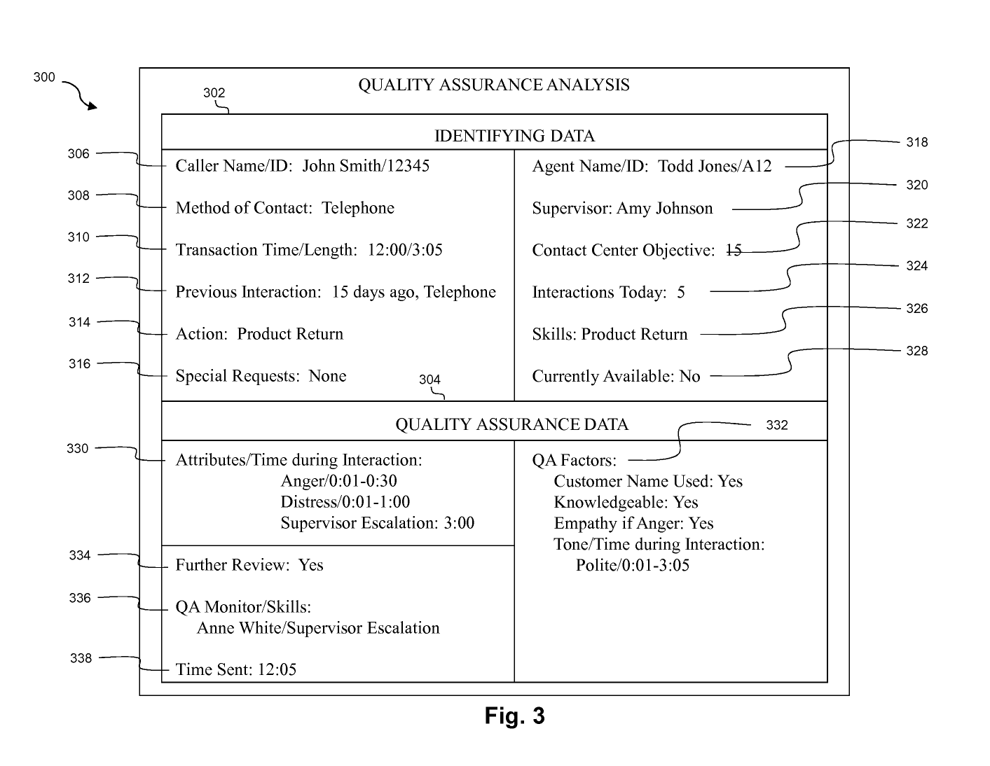

The QA device 200 includes a network interface component 214 and communications link 216 that are configured to send and receive transmissions from a contact center local network 118 or external networks such as the internet or PSTN. A storage component 218 may be used in the QA device 200 to store analysis results as well as communication data. The storage component 218 may be removed by a user and transferred to a separate device. Furthermore, a display component 220 may be included in the QA device 200 to display analysis results to a user, as shown in conjunction with FIG. 3. Alternatively, data may be transmitted by the QA device 200 to a separate device, such as a computer screen, for display.

FIG. 3 shows an exemplary display 300 for QA device 200. It should be appreciated that the principles of the communications depicted in FIG. 3 may be applied to one or more embodiments as described herein. The display 300 shows the results of an analysis of a communication between a customer and a contact center agent. Fields for identifying data 302 as well as quality assurance data 304 may be provided. As shown, the identifying data 302 fields may include data such as one or more of: caller name and ID 306, method of contact 308, interaction time and length 310, previous interaction data 312 with the same customer, action 314 requested by the customer, and special requests 316. This data may be given by a customer before or during the communication (as is common in many web-based interactions). The data may be stored in the customer history database 128. Additionally, identifying data 302 may be collected by the QA device 200 during the communication or approximated using the customer history database 128, and then optionally updated during the current communication or periodically if there are periodic communications. The identifying data 302 fields may also include, for example, one or more of: an agent name 318 and ID, supervisor 320, contact center objectives 322, daily interaction count 324 for the agent, agent skills 326, and agent availability 328.

In one embodiment, the data collected for the caller name and identification 306, action 314, and agent skills 326 may be used to match a customer to a contact center agent based on information retrieved from the customer history database 128 to begin the interaction. In the present example, John Smith may have been matched to Todd Jones because the two have previously communicated. Alternatively, the match has been made on the basis that John Smith needs to return a product and Todd Jones has experience in product returns. Information collected to complete the contact center objective 322, daily interactions 324, and current availability 328 fields may be used to determine how many interactions will be selected for QA review by the QA device 200.

The quality assurance 304 fields of the display 300 may include data such as attributes 330, QA factors 332 for an agent, whether further review 334 is (or should be) required, the selected QA monitor and/or skill focus 336, and time sent 338. Attributes 330 may include emotional cues such as anger and distress of customer, responsiveness of agent to such emotional cue(s), evidence of high value interactions (e.g., predicted or actual value threshold exceeded), legal threats, reference to a competitor, supervisor escalation, transfers to a certain destination, and discussion or resolution of issues in previous calls. Additionally, the display 300 may show QA factors 332 for evaluation of an agent. These QA factors 332 may include whether the agent used a customer name, whether the agent was knowledgeable, whether empathy was shown by the agent in the case that the customer was angry or distressed, and whether the agent used an acceptable tone throughout the conversation. The QA device 200 may track the exact time of the interaction that attributes 330 were identified. This information may be displayed at 330 and 332. After the QA device 200 has analyzed a communication, the display 300 may show whether the communication requires further review 334 by a QA monitor. In cases where attributes 330 (e.g., pre-selected depending on one or more contact center objectives) requiring such review were discovered during the communication, the QA device 200 may assign a QA monitor who will conduct a further QA analysis of the communication. The selection of a QA monitor may be based on availability, as well as skills or experience of an available QA monitor. In the example of FIG. 3, Anne White has been selected to conduct an additional QA review because she is experienced in cases of supervisor escalation, an attribute 330 identified in the present communication. Finally, the display 300 may show the time 338 that the communication is transmitted to a QA monitor or supervisor for review.

It should be understood that some or all of the information in FIG. 3 may be displayed to the QA monitor reviewing a communication or sub-set of communications, and the QA monitor will additionally have the ability to rank or rate agent performance regarding various aspects of performance in one or more fields not shown, such as the QA Factors 332, handling of attributes 330, or other factors that are a contact center objective. One such objective may be improving the handling of contacts with these factors, improving performance of an agent or group of agents, improving agent performance as to customers with a particular demographic background or type of transaction, training of new agents or agents requiring correction, etc.

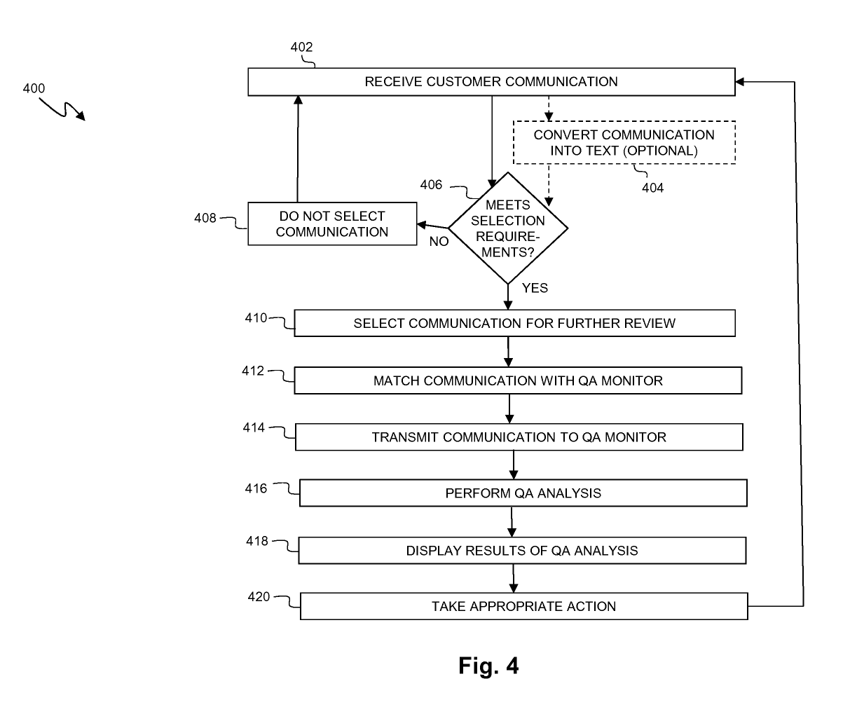

FIG. 4 is an illustrative flow chart depicting operations of a QA system 120 according to one or more embodiments of the present disclosure. Process 400 may be employed by a contact center 102, and/or performed by one or more devices, such as a QA system 120, that are associated with a contact center 102 or analytics provider. In the embodiment described below, the QA system 120 performs the process 400.

At step 402, the QA system 120 receives a customer communication. The communication may include both voice and non-voice data. The communication type may include any of the channels discussed herein or available to those of ordinary skill in the art, including without limitation one or more voice calls, voice over IP, facsimiles, emails, web page submissions, internet chat sessions, wireless messages (e.g., text messages such as SMS (short messaging system) messages or paper messages), short message service (SMS), multimedia message service (MMS), or social media (e.g., Facebook identifier, Twitter identifier, etc.), IVR telephone sessions, voicemail messages (including emailed voice attachments), video messages, video conferencing (e.g., Skype or Facetime), or any combination thereof. In one embodiment, the communication is a telephonic interaction. The communication may include data that identifies a customer-agent interaction, such as customer name or ID, customer telephone number, location of the customer, IP address, email address, and length of an interaction, as well as content from the interaction itself.

At step 404, the QA system 120 may optionally convert the content of the communication into text. In some cases, as in many web-based communications, the communication is completely conducted in text format. In other cases, the QA system 120 is able to analyze the interaction without converting content of the communication to text, and the QA system 120 does not convert the communication into text.

At step 406, the QA system 120 analyzes the communication to determine whether selection requirements are met. In exemplary embodiments, both the voice data and non-voice data associated with the communication is analyzed. For example, the QA system 120 may select communications that exhibit certain attributes. Attributes that may trigger additional review include emotional cues (e.g., anger, distress, etc.), value-exceeding-threshold transactions, legal threat, competitor reference, supervisor escalation, lack of agent empathy when there is distress or anger or other emotional cues, transfers to a certain destination, and non-first call resolution. Examples of undesirable agent behavior that can trigger further review include the use of abusive language, voice agitation (which may represent need for more frequent agent breaks or shorter work periods, or a poor or disagreeable mood), and/or lack of providing a proper response to a customer question that exhibits a lack of requisite skill or knowledge.

In exemplary embodiments, one or more selection algorithms are applied to the communication. The selection algorithm(s) is/are trained to identify a communication that requires further review. For example, if the output of the algorithm exceeds a predetermined score, the communication is selected for further review, but if the output is below the score, it is not selected. The algorithm may take into account the number, severity, and length of time for which attributes are identified in a communication. For example, a momentary occurrence of distress may not be weighted as heavily as prolonged anger or a serious legal threat.

Additionally, the selection algorithm may take into account the objectives of the contact center 102 (which may include meeting a particular review threshold or benchmark, such as reviewing a percentage of calls or reviewing a percentage of calls that are selected per month). In various embodiments, the contact center 102 provides its objectives to the QA system 120. Objectives may include retaining customers, generating increased revenue, understanding a decrease in revenue, providing an outstanding customer experience, identifying reasons for the communication, resolution of customer inquiries or complaints, identifying knowledgeable agents (e.g., for compensation decisions or promotion), low call talk time duration, agent courtesy, agent's ability to follow procedures, and agent's adherence to a script, among other reasons. These objectives may be analyzed using the selection algorithms described herein. In one embodiment, the selection algorithm is updated regularly to include data from past interactions and information from the customer history database 128. In this way, repeated interactions with customers may be identified and weighted more heavily. In some embodiments, the contact center objectives are dynamic and change over time, and the selection algorithm is updated to reflect one or more new objectives. In other embodiments, a manager or QA analyst can pre-select the objective(s).

In various embodiments, the selection algorithm(s) include one or more linguistic algorithms that can be applied to the text of the communication to determine whether the communication exhibits some of the attributes, such as anger, legal threat, and/or competitor reference. A linguistic algorithm(s) is typically created by linguistic analysts and such algorithm(s) are typically trained using previously analyzed customer-agent communications. In one embodiment, the analyst(s) can review communications and manually label keywords or terms that are relevant to an identified attribute (e.g., those that show emotion or distress). For instance, the use of profanity can indicate that a customer is angry and use of the word “sue” or “suit” or “criminal” indicates a legal threat. The computer-implemented algorithm is trained to check for those keywords and the number of times they are used in the communications. A more sophisticated algorithm may be used that additionally checks for use of the keywords in context, or where in the conversation they occur. For example, a threat of suit at the start of a contact followed by lengthy interaction may suggest minimal risk of a legal threat and a skilled agent who handled the complaint well. One master algorithm containing many specific algorithms may also be used.

The QA system 120 may also, or alternatively, apply distress analysis techniques (or other emotional cue analysis) to the communication to detect distress or emotional cue events. For example, when applied to a telephone-based interaction session, linguistic-based distress analysis may be conducted on both a textual translation of voice data and an audio file containing voice data. Accordingly, linguistic-based analytic tools as well as non-linguistic analytic tools may be applied to the audio file. In particular, the QA system 120 may apply spectral analysis to the audio file voice data while applying a human speech/linguistic analytical tool to the text file. Linguistic-based analysis and computer-implemented algorithms for identifying distress can be applied to the textual translation of the communication. Resultant distress data may be stored in the database 116, in the customer history database 128 or elsewhere for subsequent analysis of the communication. Distress event data and other linguistic-based analytic data may be considered behavioral assessment data in some instances. Further, in other embodiments, the QA system 120 may be operable to apply voice printing techniques to the unstructured audio from various customer interactions. For example, a recorded sample may be utilized to identify, or facilitate identification of, a customer in the event the customer did not supply any identifying information. Voice print information may also be stored in the customer history database 128.

When the communication does not meet the selection criteria, the communication is not selected for further QA analysis at step 408. When a communication is found to have met selection requirements, it is selected for further QA review at step 410. In some embodiments, the communications that are selected are forwarded to the contact center 102 or directly to an analytics provider for QA review. The QA system 120 then matches the communication with a QA monitor in step 412. In one embodiment, the QA system 120 includes an assignment engine 124 that performs the function of matching a QA monitor with a selected communication. This match may be made based on one or more of a variety of factors, such as the availability of the QA monitor, the skills or experience of the QA monitor, and/or the familiarity of the QA monitor with the agent or customer participating in the communication or the type of transaction. The assignment engine 124 may make matches based on comparing various agent data and QA monitor data. For instance, the assignment engine 124 assesses the skills of available QA monitors to establish which QA monitor possesses the skills that are most needed for the customer communication. For example, a QA monitor with extensive experience in dealing with customers threatening legal action may be assigned a communication where a customer states that he or she is planning to sue, or customers needing supervisor escalation may be assigned where supervisors are brought in to communication with a customer.

In step 414, the communication and data associated with the communication is transmitted to the QA monitor by, for example, a communication engine 126 or module of the QA system 120. This data may include identifying data, content of the communication, and any of the QA system 120 results.

In step 416, the QA analysis is performed. In this embodiment, the QA analysis is performed by the assigned QA monitor. The QA monitor can determine whether or not the agent greeted a caller by name, used a pleasant tone, was knowledgeable and helpful, and/or asked if there was anything else the agent could help the caller with. The QA monitor can then record any analysis on a form. In some embodiments, the assignment engine 124 associates the call for review with the appropriate QA review form.

In alternative embodiments, the QA system 120 performs the QA analysis itself, rather than the QA monitor. The QA system 120 (e.g., the analytics engine 122) determines whether the agent performed certain actions that demonstrate excellent customer service by, for example, identifying the tone used by the agent, whether the agent used customer name, whether the agent seemed knowledgeable, whether the agent followed a script, whether the agent was able to resolve the customer problem, etc.

In some embodiments, the analytics engine 122 can identify whether a video capture should be started of the agent's screen, since it is not always economically efficient to capture all of the communication on a video. The analytics engine 122 can identify whether screen capture should be started where not all screen capture information is currently captured. For example, if the communication includes many of the various attributes discussed above, then a video capture should be initiated. In some embodiments, this can be done in real-time while the communication is ongoing between customer and agent (or after escalation from agent to a supervisor, for QA review of supervisor handling)

In step 418, the results of the QA analysis are displayed or otherwise provided, such as shown in FIG. 4. In some embodiments, a report is generated that improves the ability to evaluate a specific agent in relation to a specific communication and/or in general. For example, the report may integrate the results of customer surveys and supervisor evaluation reports, and enable the evaluation of the quality of the agent based on both customer and supervisor input.

In step 420, appropriate action is taken with regard to the results. Process 400 is useful in improving the quality of customer interactions with agents, supervisors, and ultimately customer relationships. The results of the analysis may be subsequently used by a supervisor or trainer to evaluate effectiveness of an agent or take other remedial action such as call back of a customer or training for the agent or supervisor. For example, the agent may be instructed in how to respond and interact with a similar customer in the future. In some embodiments, the results may be used to distribute future customer tasks or communications to the best available agent for that customer, or best available supervisor for a particular type of issue requiring escalation.

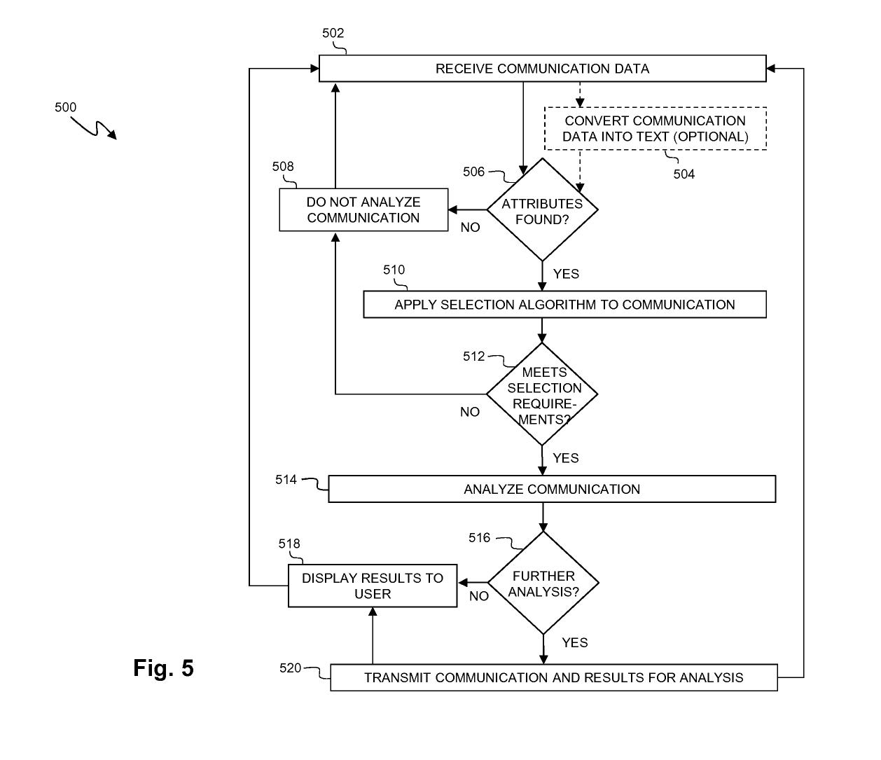

FIG. 5 is an illustrative flow chart depicting operations of a QA system 120 according to one or more embodiments. Process 500 may be employed by a contact center 102, and/or performed by one or more devices such as a QA system 120 that is associated with a contact center 102, or as noted above any part or all of this process 500 may be handled by an analytics provider either on-site at the contact center or remotely located. Process 500 describes the steps taken by a QA system 120 that automatically performs a QA analysis on a communication.

At step 502, the QA system 120 receives customer communication data. This may include data that identifies a communication, such as customer name or ID, telephone number, location of the customer, customer history, IP address, email address, and length of an interaction, as well as content from the interaction itself.

At step 504, the QA system 120 may optionally convert the content of the communication into text. At step 506, the QA system 120 analyzes the communication to determine whether attributes (such as those listed above) are present. If no attributes are identified by the system 120, the communication is not analyzed for QA purposes 508. If attributes are identified, a selection algorithm is applied to the communication at step 510. The selection algorithm is populated with selection criteria, allowing the QA system 120 to determine whether the communication requires further QA review at step 512.

At step 514, the communication is selected for further QA review and is analyzed by the QA system 120. This analysis may take into account attributes identified by the QA system 120 as well as selection criteria. In one embodiment, additional factors are used in the analysis 514 of the communications that were not used in the selection of the communication for QA review. In some cases, the agent's performance in the communication is scored or ranked, or both. In other cases, the analysis 514 determines a customer satisfaction level.

After the QA analysis 514 is performed, the QA system 120 determines whether further analysis, such as by a human QA monitor, is required at step 516. For example, if the communication involves a particularly valuable customer with a net worth or income exceeding a selected threshold, a transaction that exceeds a selected threshold, or a customer in a loyalty program or exceeding a threshold number of interactions or purchases, the QA system 120 may decide that the communication needs additional review or may use this as a factor in making the determination of further review being required. In another example, if the communication involves an agent that has been cited numerous times, the QA system 120 may decide that a QA supervisor needs to review the communication.

If no further analysis is required, the QA system 120 displays the analysis results to a user (e.g., a contact center manager or supervisor) at step 518. A display 300, such as that shown in the example of FIG. 3, may be used at this step. The user may customize the various objectives, attributes, emotional cues, and thresholds, for example, disclosed herein.

If further analysis is required, the QA system 120 transmits the information for the communication, including identifying information and analysis results, to a QA monitor for further review at step 520. Further review may be required in cases involving serious problems or repeated interactions, as well as other selected attributes depending on one or more contact center objectives. Examples of serious problems include when a customer exhibits or expresses negative emotions such as anger or distress, or makes a legal threat or a competitor reference; when a high value transaction is at risk (e.g., a customer who is likely to make a large purchase appears to be backing out of the purchase); when the interaction is transferred to a certain destination (e.g., when an interaction is escalated to a supervisor); when an agent exhibits negative behavior (e.g., the agent fails to express empathy when a customer is in distress); and when a call is not resolved during a first interaction. Additionally, further review may be used to assess the performance of the QA system 120 or the performance of one or more agents or QA monitors generally, or specifically.

In one embodiment, the outcome of step 516 may depend on whether an agent recorded a communication properly. In some cases, an agent records only a portion of his or her total communications to conserve memory space. The QA system 120 may be used to decide if this decision was appropriate in light of the attributes identified in step 506. For example, if an agent decided not to record a communication that was later identified to include many attributes, such as anger and supervisor escalation, the QA system 120 may determine that the agent's decision was wrong. In this case, the QA system 120 may conduct a QA analysis and transmit the results for further review at step 520, give feedback directly to an agent regarding the decision and corrective teaching for future interactions, or both. The QA system 120 provides for input associated with the QA evaluation, which may be by a QA monitor or another user (e.g., a contact center manager or supervisor), and each record of a customer/agent or customer/supervisor communication can be associated accordingly with such input. A meta-report of all such QA analysis for a given time period, specified agent or group of agents, or the like, can be prepared and provided to a user, as well.

In view of the present disclosure, it will be appreciated that various methods and systems have been described according to one or more embodiments for performing a QA analysis. Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to allow a quick determination of the nature of the technical disclosure. It is submitted with the understanding that it will not be used to interpret or limit the scope or meaning of the claims.

1. An automated quality assurance system configured to reduce the number of communications reviewed, which comprises:
a processor; and
a non-transitory computer readable medium operably connected to the processor, wherein the non-transitory computer readable medium comprises a plurality of instructions stored in association therewith that are accessible to, and executable by, the processor, wherein the plurality of instructions comprises:
instructions that, when executed, receive a plurality of communications each between a customer and a customer service agent associated with a contact center;
instructions that, when executed, convert each of the plurality of communications into text;
instructions that, when executed, analyze the text and identifying data of each of the plurality of communications based on voice data and non-voice data to determine a score for each of the plurality of communications based on at least one attribute or contact center objective;
instructions that, when executed, select a sub-set of the plurality of communications for review based on the determined score;
instructions that, when executed, populate an electronic quality assurance analysis form with the identifying data, including a customer name;
instructions that, when executed, transmit the sub-set of communications and the populated quality assurance analysis form to one or more quality assurance monitors; and
instructions that, when executed, display to a user results of a quality assurance analysis by the one or more quality assurance monitors.

2. The system of claim 1, wherein each communication comprises a real-time electronic interaction, a recorded telephone call, a real-time telephone call, or a recorded electronic interaction.

3. The system of claim 2, wherein the recorded electronic interaction is a video recording.

4. The system of claim 1, wherein the at least one attribute comprises an emotional cue, an interaction that does or is predicted to exceed a value threshold, a legal threat, a reference to a competitor, a supervisor escalation, a transfer to a certain destination, and a multiple contact resolution.

5. The system of claim 1, wherein the non-transitory computer-readable medium further comprises instructions that, when executed, match the sub-set of communications to the one or more quality assurance monitors according to availability of the quality assurance monitor and one or more skills of the quality assurance monitor.

6. (canceled)

7. The system of claim 1, wherein the non-transitory computer-readable medium further comprises instructions that, when executed, recommend an action to be taken based on the results of the quality assurance analysis.

8. The system of claim 7, wherein the recommended action comprises training the customer service agent, routing a future communication from a customer to a suitable customer service agent, or both.

9. (canceled)

10. The system of claim 1, wherein the results of the quality assurance analysis comprise one or more of whether a customer name was used, whether the customer service agent was knowledgeable, and whether the customer service agent used a suitable tone.

11. The system of claim 1, wherein the non-transitory computer-readable medium further comprises instructions that, when executed, identifies whether video capture of a customer service agent screen should be started or actually starts video capture in real-time.

12. A method of conducting a quality assurance analysis to reduce the number of communications reviewed, which comprises:
receiving, by a processor, a plurality of communications, each between a customer and a customer service agent associated with a contact center;
converting, by the processor, each of the plurality of communications into text;
identifying, by the processor, attributes and identifying data in the text of each of the plurality of communications based on voice data and non-voice data to determine a score for each of the plurality of communications based on at least attribute or contact center objective;
selecting, by the processor, a sub-set of the plurality of communications for review based on the determined score;
performing a first quality assurance analysis on the sub-set of communications;
populating, by the processor, an electronic quality assurance analysis form with the identifying data including a customer name; and
displaying to a user, by the processor, the results of the first quality assurance analysis to a user.

13. The method of claim 12, wherein the attributes comprise one or more of an emotional cue, an interaction that does or is predicted to exceed a value threshold, a legal threat, reference to a competitor, supervisor escalation, a transfer to a certain destination, and non-first call resolution.

14. The method of claim 12, which further comprises recommending an action to be taken based on the results of the first quality assurance analysis.

15. The method of claim 14, wherein the recommended action comprises one or more of training of the customer service agent and routing a future communication to a suitable customer service agent.

16. The method of claim 12, which further comprises determining that a second quality assurance review is needed based on the results of the first quality assurance analysis.

17. The method of claim 16, wherein determining that a second quality assurance review is needed comprises determining that problems, repeated interactions, or both, are present in the communication.

18. The method of claim 12, which further comprises identifying whether video capture of a customer agent screen should be started or actually starting real-time video capture.

19. An automated quality assurance system configured to reduce the number of communications reviewed, which comprises:
an analytics engine configured to:
receive a plurality of communications each between a customer and a customer service agent associated with a contact center;
convert each of the plurality of communications into text;
analyze the text and identifying data of each of the plurality of communications based on voice data and non-voice data to determine a score for each of the plurality of communications based on at least one attribute or contact center objective;
select a sub-set of the plurality of communications for review based on the determined score;
populate an electronic quality assurance analysis form with the identifying data, including a customer name;
a communication engine configured to transmit the sub-set of communications and the populated electronic quality assurance analysis form to one or more quality assurance monitors; and
a display component configured to display to a user results of a quality assurance analysis by the one or more quality assurance monitors.

20. The system of claim 19, wherein the at least one attribute comprises an emotional cue, evidence or prediction of an interaction exceeding a value threshold, a legal threat, reference to a competitor, supervisor escalation, a transfer to a certain destination, and non-first call resolution.

21. The system of claim 19, further comprising matching the sub-set of communications with the one or more quality assurance monitors based on availability of the one or more quality assurance monitors and one or more skills of the one or more quality assurance monitors.

22. The system of claim 19, wherein the results of the quality assurance analysis comprise one or more of whether a customer name was used, whether the customer service agent was knowledgeable, and whether the customer service agent used a suitable tone.

23. The system of claim 19, wherein the analytics engine is further configured to recommend actions to be taken based on the results of the quality assurance analysis.

24. The system of claim 23, wherein the recommended action comprises one or more of training of the customer service agent and routing a future communication to a suitable customer service agent.

25. A non-transitory computer readable medium comprising a plurality of instructions, which in response to a computer system, cause the computer system to perform a method comprising:
receiving a plurality of communications each between a customer and a customer service agent associated with a contact center;
converting each of the plurality of communications into text;
analyzing the text and identifying data of each of the plurality of communications based on voice data and non-voice data to determine a score for each of the plurality of communications based on at least one attribute or contact center objective;
selecting a sub-set of the plurality of communications for review based on the determined score;
performing a first quality assurance analysis on the sub-set of communications;
populating an electronic quality assurance analysis form with the identifying data, including a customer name;
displaying results to a user of the first quality assurance analysis to a user; and
recommending that one or more actions be taken.

26. The method of claim 25, wherein the at least one attribute comprises evidence of an emotional cue, evidence or prediction of an interaction exceeding a value threshold, a legal threat, reference to a competitor, supervisor escalation, a transfer to a certain destination, and non-first call resolution.

27. The method of claim 25, wherein performing the first quality assurance analysis comprises one or more of determining whether a customer name was used, whether the customer service agent was knowledgeable, and whether the customer service agent used a suitable tone.

28. The method of claim 25, wherein the recommended one or more actions comprises training of the customer service agent and routing a future communication to a suitable customer service agent.

29. The method of 25, which further comprises identifying whether video capture of a customer agent screen should be started or starting video capture in real-time.

30. The method of claim 25, which further comprises determining that a second quality assurance review is needed based on the displayed results of the first quality assurance analysis.

31. (canceled)

32. The system of claim 1, wherein the non-transitory computer-readable medium further comprises instructions that, when executed, perform audio analysis on voice data for each of the plurality of communications to detect distress and the audio analysis comprises spectral analysis of an audio file of the voice data.

33. The system of claim 32, wherein the non-transitory computer-readable medium further comprises:
instructions that, when executed, select a sub-set of the communications for quality assurance review based on a detection of distress; and
instructions that, when executed, track a time in each communication of the selected sub-set of communications when distress was detected.
